(19) United States
(12) Patent Application Publication
(10) Pub. No.: US 2005/0231327 A1
(43) Pub. Date: Oct. 20, 2005

(54) Method for selecting one or more transponders

(76) Inventors: Ulrich Friedrich, Ellhofen (DE); Michael Pangels, Ludwigsburg (DE)

Correspondence Address: BIRCH STEWART KOLASCH & BIRCH, PO BOX 747, FALLS CHURCH, VA, 22040-0747, US

(21) Appl. No.: 11/104,438

(22) Filed: Apr. 13, 2005

(30) Foreign Application Priority Data
Apr. 14, 2004 (DE) 10 2004 018 540.9

(51) Int. Cl. H04Q 5/22

(52) U.S. Cl. 340/10.2; 340/10.42; 340/10.32

(57) ABSTRACT

A method and system is provided for selecting one or more transponders from a plurality of transponders by a base station, in which a random number generated in a given transponder determines a point in time when the transponder in question transmits an identification to the base station. The base station transmits a selection command, then, in order to determine whether at least one transponder is addressed by the selection command, all addressed transponders substantially simultaneously transmit an identification to the base station at a first point in time, and if more than one transponder is addressed, each addressed transponder transmits its identification to the base station at least once more at an additional point in time. The additional point in time being determined by the value of the random number generated or to be generated in the relevant transponder.

This nonprovisional application claims priority under 35 U.S.C. § 119(a) on German Patent Application No. DE 102004018540.9, which was filed in Germany on Apr. 14, 2004, and which is herein incorporated by reference.

### BACKGROUND OF THE INVENTION

1. Field of the Invention

The present invention relates to a method and apparatus for selecting one or more transponders from a plurality of transponders by a base station.

2. Description of the Background Art

Selection methods, which are also called anticollision methods, are used in, for example, contactless identification systems or so-called radio frequency identification (RFID) systems. A system of this nature typically includes a base station or a reader and a plurality of transponders or remote sensors, which are located in a response area of the base station at the same time. The transponders and their transmitting and receiving devices customarily do not have an active transmitter for data transmission to the base station. Such non-active systems are called passive systems if they do not have their own energy supply, and semi-passive systems if they have their own energy supply. Passive transponders take the energy they require for their supply from the electromagnetic field emitted by the base station.

In general, backscatter coupling is used to transmit data from a transponder to the base station using UHF or microwaves in the far field of the base station. To this end, the base station emits electromagnetic carrier waves, which the transmitting and receiving device in the transponder modulates and reflects appropriately for the data to be transmitted to the base station using a modulation method. Typical modulation methods for this purpose are amplitude modulation, phase modulation and amplitude shift keying (ASK) subcarrier modulation, in which the frequency or the phase position of the subcarrier is changed.

If data transmission is to take place between only one transponder or a group of transponders and the base station, a selection process must be carried out prior to the data transmission in question.

In this context, a basic distinction is made between stochastic and deterministic selection methods. A detailed description of deterministic selection methods and also stochastic selection methods can be found, for example, in the textbook by Klaus Finkenzeller, RFID-Handbuch, 3^{rd} edition, HANSER, 2002, see especially Chapter 7.2, Vielfachzugriffsverfahren [multi-access procedures], which has been published in English by John Wiley & Sons, and which is incorporated herein by reference.

In contrast to deterministic methods, stochastic methods do not presuppose a unique identification (U-ID) with a structure such as those described in the ISO 15963 standard. Assignment of such U-lDs is undertaken by bodies including a variety of manufacturer-independent organizations, for example the EAN/UCC or the IATA. However, the assignment can also be made by a manufacturer on its own. As a result, it is not always possible to ensure the uniqueness of U-IDs in open systems in which transponders from arbitrary manufacturers may be located in the response area of a base station. Stochastic methods permit selection even in these cases. Examples of such stochastic methods include, for example, the ALOHA method, the slotted ALOHA method, and the dynamic slotted ALOHA method.

The ALOHA method is a transponder-controlled, stochastic method in which the transponders transmit their data for transmission with a time offset. As a rule, the time offset is set on the basis of a random number generated in the transponder. If multiple transponders transmit an identification within the same time slot, a collision occurs. This generally prevents the base station from being able to receive the transmitted data error-free.

In the slotted ALOHA method, the probability of collision is significantly reduced as compared to the plain ALOHA method. It is a base-station controlled, stochastic method in which the transponders are active, i.e. begin transmission of data, only at defined, synchronous points in time. To this end, the base station prescribes numbered time slots, or slots, and the transponders each generate a random number, with every transponder whose random number corresponds to the number of a time slot transmitting data or an identification to the base station in this time slot. To initiate the selection process, the base station generally transmits a command to the transponders that indicates the start of a selection procedure. After reception of the command, the transponders store the applicable random numbers, which for example were previously calculated in the transponder. When only one transponder transmits an identification within a time slot, this transponder is selected within the time slot, or can be selected by the base station by transmission of an acknowledgement signal. The base station can then, for example, perform write and/or read operations on this transponder. When multiple transponders transmit an identification within the same time slot, a collision occurs. Depending on the bit coding, the base station can detect such a collision immediately or after a delay, and can skip the corresponding time slot and attempt to process time slots in which no collision occurs, or can initiate a new selection procedure by sending an appropriate command to the transponders. Since the transponders typically generate or store new random numbers, the possibility exists that no collision will occur.

The dynamic slotted ALOHA method, in which the number of available time slots can be controlled by the base station, was created in order to solve this problem. One such method is described in ISO 18000-6 FCD Type A, for example. In this method, the base station can initiate a selection process with, for example, a small number of time slots. If collisions frequently occur in this case, the base station can initiate a new selection process in which the number of time slots is increased, which reduces the probability of collisions. However, a dynamic method of this nature requires a relatively great amount of time, since it can take a great deal of time to set the optimal number of time slots. Moreover, because of its complexity, it requires a correspondingly complex circuit design.

It is a characteristic of all the slotted ALOHA methods mentioned that the number of required slots increases sharply when the number of transponders in the response area of the base station rises. In order to solve this problem, ISO 18000-6 FCD Type A proposes preselection by a group select command. In this context, only a subset or group from among all transponders is addressed. When such a preselection is placed first, the base station does not at first know whether one transponder or how many transponders are addressed by the preselection and subsequently participate in the selection process. Since it is subsequently necessary in every slot to test whether a transponder sends an identification, the selection process requires a relatively large amount of time even when no transponder is addressed by the preselection. The same applies to a slotted selection process with no preselection, since all slots must be tested here as well.

### SUMMARY OF THE INVENTION

It is therefore an object of the present invention to provide a method and apparatus for selecting one or more transponders that permits a relatively time-efficient selection while taking into account a variety of selection scenarios.

In accordance with an embodiment of the invention, the base station transmits a selection command, then, in order to determine whether at least one transponder is addressed by the selection command, all addressed transponders substantially simultaneously transmit an identification to the base station at a first point in time, and if more than one transponder is addressed, each addressed transponder transmits its identification to the base station at least once more at an additional point in time, wherein the additional point in time can be determined by the value of a random number generated or to be generated in the relevant transponder. As a result of the simultaneous transmission of the identification at the first point in time, the base station can recognize whether at least one transponder is addressed by the selection command.

If no transponder transmits its identification to the base station at the first point in time, the current selection can be aborted or terminated immediately without executing additional process steps, which are not necessary in this selection scenario. This drastically reduces the amount of selection time required in this case.

When only one transponder transmits its identification at the first point in time, this transponder is selected or can be selected by the base station by transmission of an acknowledgement signal. The base station can then perform write and/or read operations on this transponder, for example.

If multiple transponders send or transmit an identification at the first point in time, a collision typically occurs. Depending on the bit coding, the base station can detect such a collision immediately or after a delay. In this case, each transponder transmits its identification to the base station once again at a point in time that depends on its particular random number. This step corresponds essentially to the conventional ALOHA-based selection process. If the data transmission between base station and transponders takes place in full-duplex operation, a command can be transmitted from the base station to the transponders immediately upon occurrence or detection of a collision, which command indicates or accomplishes a change to a subsequent slot in a slotted ALOHA process, for example. This is also possible with asynchronous data transmission in full-duplex operation.

In a further example embodiment, a transponder whose random number corresponds to the first point in time repeatedly generates a random number until the number no longer corresponds to the first point in time. The additional point in time can be determined using the newly generated random number. If more than one transponder transmits its identification at the first point in time, each transponder transmits its identification again at the additional point in time. However, a random number that corresponds to the first point in time can be invalid since the point in time for repeated transmission of the identification should be different from the first point in time. In this way, transponders whose particular random number corresponds to the first point in time can be assigned a new and valid point in time for repeated transmission of their identification.

In a further embodiment, possible values of a random number in a given transponder correspond to the points in time after the first point in time. This makes it possible to avoid the need to regenerate the random number in the transponders whose random number corresponds to the first point in time.

In yet a further example embodiment, in a slotted ALOHA method, the first point in time can lie within a slot, in particular the first slot following the selection command. If a slotted ALOHA method is used, the detection of whether at least one transponder is addressed by the selection command can take place within a slot predefined by the base station. This simplifies the evaluation, since control is performed centrally by the base station.

Also, a transponder whose random number corresponds to the slot of the first point in time can repeatedly generate a random number until the number no longer corresponds to the slot of the first point in time. A random number that corresponds to the slot of the first point in time, i.e. the slot during which all addressed transponders transmit their identification to the base station, is invalid since the repeated transmission of the identification should take place in a different slot. In this way, transponders whose particular random number corresponds to the slot of the first point in time can be assigned a new and valid slot for repeated transmission of their identification.

Furthermore, the random numbers can be assigned to the slots that follow the first slot after the selection command. This makes it possible to avoid the need to regenerate the random number in the transponders whose random number corresponds to the slot of the first point in time.

In a further example embodiment, the regeneration of the random number is terminated upon reception of a synchronization mark that is transmitted by the base station. When data transmission between the base station and a transponder is synchronous, synchronization marks or symbol delimiters, which are also called notches, are generated by the base station. In this case, the transponder changes the backscattered signal synchronously with the synchronization marks generated and transmitted by the base station. Moreover, the synchronization marks can be used for transmitting data from the base station to the transponder. The value of a symbol transmitted by the base station in this case is determined, for example, by the interval or the period between two sequential synchronization marks. For example, if the period is greater than a settable threshold value, the value of the symbol is “1,” otherwise it is “0.” In this context, the reception of such a synchronization mark can serve as a trigger condition within a transponder for the beginning or end of random number generation. This simplifies the implementation of the process in a transponder, since the trigger conditions are generated centrally by the base station.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a diagram of a time sequence of a selection process according to an example embodiment of the present invention;

FIG. 2 is a diagram of a time sequence of a selection process according to an alternate example embodiment of the present invention; and

FIG. 3 is a block diagram of a transmission system.

### DETAILED DESCRIPTION

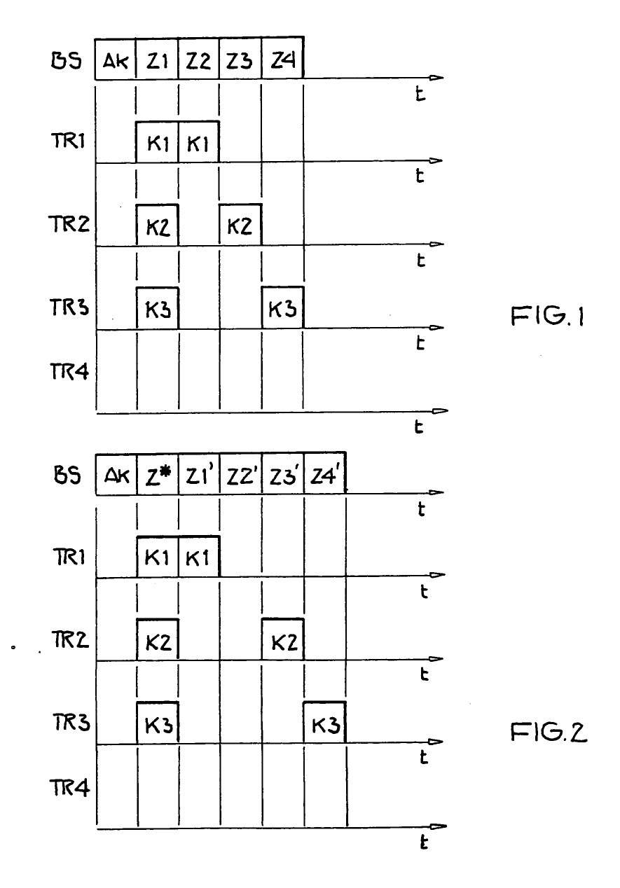

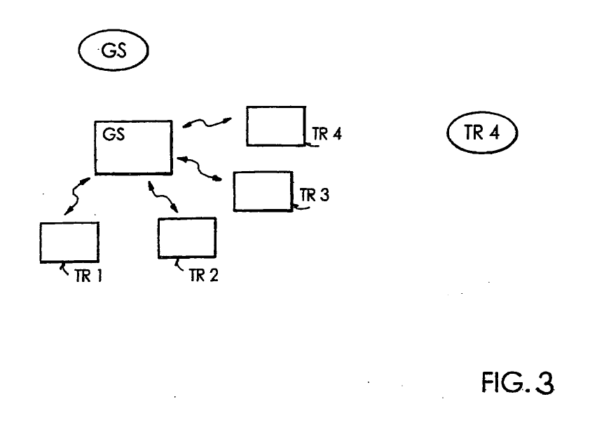

FIG. 1 shows a diagram of a time sequence of a first example embodiment of a selection process in which a base station BS and four transponders TR1 to TR4 participate, as shown in FIG. 3. The selection method shown can be based on a slotted ALOHA method in which the base station defines numbered time slots Z1 to Z4. The selection process is initiated in that the base station BS transmits a selection command AK. The selection command AK comprises a group select command, which means that only a subset of all transponders TR1 to TR4 in the response area of the base station is addressed. In this case the transponders TR1 to TR3 are preselected by the group select command, while the transponder TR4 does not participate in the selection process shown.

After receiving the selection command AK, the transponders TR1 to TR3 each generate a random number, which is stored in the relevant transponders TR1 to TR3. The random number generation can take place using what is known as a linear feedback shift register (LFSR). The random number of the transponder TR1 can correspond to time slot Z1, the random number of the transponder TR2 can correspond to time slot Z3, and the random number of the transponder TR3 can correspond to time slot Z4, in the example shown in FIG. 1.

The base station now transmits a command that is not shown, which indicates the first time slot, or slot Z1. Each of the transponders TR1 through TR3 substantially simultaneously transmits its identifications K1, K2 or K3 to the base station BS in the first time slot Z1. The base station BS detects, on the basis of the resulting collision, that at least two transponders are participating in the selection process. If the data transmission between base station BS and the transponders TR1 through TR3 takes place in full-duplex operation, a command can be transmitted from the base station BS to the transponders TR1 through TR3 immediately after the occurrence or detection of the collision, i.e. before the respective identifications K1 through K3 are fully transmitted, which command effects a change to the subsequent time slot Z2, since it is already clear as soon as the first occurrence of a collision in a bit position of the backscattered signal that at least two transponders are substantially simultaneously transmitting their identification. Of course this also applies in asynchronous data transmission.

If no transponder transmits an identification during the time slot Z1, the selection process could terminate immediately, and if necessary started anew with a modified preselection. If only one transponder transmits its identification, this transponder would be selected, or could be selected by the base station by transmission of an acknowledgement signal. The base station can then, for example, perform write and/or read operations on this transponder.

The random number of the transponder TR1 corresponds to the point in time or time slot Z1, in which all transponders TR1 to TR3 transmit their identification. Since collisions take place in this time slot whenever more than one transponder participates in the selection process, a transponder whose random number corresponds to this time slot cannot be selected within this selection process without generating a random number anew. This requires a repetition of the entire selection process in which all transponders generate random numbers anew. But in this case, the possibility then exists that the transponder in question will now generate a random number that does not correspond to the time slot Z1.

To avoid such a shortcoming, in the selection method according to the invention the transponder TR1 repeatedly generates a random number until the number no longer corresponds to the time slot Z1. In the example embodiment shown, the new random number thus produced corresponds to the time slot Z2. The other transponders TR2 and TR3 do not generate new random numbers.

The base station now transmits a command that is not shown, which indicates the second time slot Z2. Since the random number of the transponder TR1 corresponds to this time slot Z2, as explained above, the transponder TR1 sends its identification K1 within this time slot Z2 to the base station BS. The transponder TR1 can now be selected within this time slot Z2.

After this, the base station BS now transmits additional commands indicating the time slots Z3 and Z4. The transponder TR2 transmits its identification K2 in accordance with its random number in the time slot Z3, and the transponder TR3 transmits its identification K3 in accordance with its random number in the time slot Z4, where a selection can take place in each case.

After the time slot Z4, the selection process ends. Unlike a conventional, slotted selection method, the selection process shown in FIG. 1 does not require any additional slots. However, one slot is used to determine whether any transponders are in fact addressed by the selection command; in the example embodiment shown, this is the first slot Z1.

FIG. 2 shows a diagram of a time sequence of another example embodiment. As compared to the selection process shown in FIG. 1, this process requires an additional slot. The slot in which all addressed transponders TR1 to TR3 simultaneously transmit their identification is labeled Z* here. In contrast to the process described in FIG. 1, however, no possible value of a random number corresponds to the slot Z*. Here, the random numbers of the transponders TR1 through TR3 are associated with the slots Z1′ through Z4′, which follow the first slot Z* after the selection command AK. In the example embodiment shown, the random number of the transponder TR1 corresponds to the time slot Z1′, the random number of the transponder TR2 corresponds to the time slot Z3′, and the random number of the transponder TR3 corresponds to the time slot Z4′. In contrast to FIG. 1 the repeated generation of a random number in the transponder TR1 can be omitted, although an additional slot is required. Otherwise the rest of the selection takes place in similar fashion to the selection shown in FIG. 1.

The ALOHA-based selection methods or selection processes shown permit a relatively time-efficient selection while taking into account a variety of selection scenarios. The example embodiments illustrated each show a slotted selection process. However, the inventive method can of course also be used in the context of non-slotted ALOHA methods, or other methods.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A method for selecting one or more transponders from a plurality of transponders by a base station, the method comprising the steps of:
transmitting, by the base station, a selection command; and
determining whether at least one transponder is addressed by the selection command in that all addressed transponders substantially simultaneously transmit an identification to the base station at a first time point,
wherein if more than one transponder is addressed, each addressed transponder transmits its identification to the base station at least once more at an additional point in time on the basis of a generated random number that each transponder generates, the generated random number determining a time point when the transponder transmits an identification to the base station

2. The method according to claim 1, wherein a transponder whose random number corresponds to the first time point repeatedly generates a new random number such that the new random number no longer corresponds to the first time point, and wherein the additional time point is determined using the new generated random number.

3. The method according to claim 1, wherein possible values of the generated random number in given transponder correspond to the time points after an initial time point.

4. The method according to claim 1, wherein, in a slotted ALOHA selection method, the first time point lies within a slot, in particular a first slot, after the selection command.

5. The method according to claim 4, wherein a transponder whose random number corresponds to the slot of the first time point repeatedly generates a new random number until the new random number no longer corresponds to the slot of the first time point.

6. The method according to claim 4, wherein the random numbers are assigned to slots that follow the initial slot after the selection command.

7. The method according to claim 2 or 5, wherein the regeneration of the new random number is terminated upon receipt of a synchronization mark that is transmitted by the base station.

8. The method according to claim 1, wherein the one or more transponders are backscatter-based transponders.

9. The method according to claim 1, wherein the selection method is based on an ALOHA method or a slotted ALOHA.

10. A transmission system comprising:
a plurality of transponders; and
a base station for transmitting a selection command to the plurality of transponders, the selection command including a group select command for addressing a subset of transponders from the plurality of transponders,
wherein each of the subset of transponders generates a random number that indicates a time slot for transmitting to the base station,
wherein each of the subset of transponders transmit to the base station an identification during a first time slot, and
wherein, if a transponder of the subset of transponders generated a random number indicating transmission during the first time slot, that transponder repeatedly generates a new random number until the new random number indicates a time slot that is different from the first time slot.
